(19) United States
(12) Patent Application Publication
(10) Pub. No.: US 2018/0308377 A1
(43) Pub. Date: Oct. 25, 2018

(54) Mixed-Reality System

(71) Applicant: University of Essex Enterprises Limited, Colchester (GB)

(72) Inventors: Anasol PENA-RIOS, Colchester (GB); Victor CALLAGHAN, Colchester (GB); Michael GARDNER, Colchester (GB); Daniyal ALGHAZZAWI, Colchester (GB); Mohammed ALHADDAD, Colchester (GB)

(21) Appl. No.: 15/763,395

(22) PCT Filed: Sep. 27, 2016
(86) PCT No.: PCT/GB2016/053002

§ 371 Date: Mar. 26, 2018

(30) Foreign Application Priority Data
Sep. 28, 2015 (GB) 1517101.0

(51) Int. Cl. G09B 5/12; G06T 19/00; G06F 3/0481; G09B 5/02

(52) U.S. Cl. CPC G09B 5/12; G06T 19/006; G06T 2219/024; G09B 5/02; G06F 3/04815

(57) ABSTRACT

A system for generating at least one virtual object corresponding to at least one real object. The system is arranged to update the virtual object responsive to changes in state of the physical object, and the system is arranged to update the physical object responsive to changes in the state of the virtual object.

### TECHNICAL FIELD

The present invention relates to techniques for generating virtual objects corresponding to real, physical objects. In certain embodiments, the invention relates to the provision of a deconstruction manager for synchronising virtual objects and real, physical objects.

### BACKGROUND

Mixed-Reality (MR) is the spectrum that connects physical environments, absent from virtual representations of any kind, to completely virtual ones, allowing the co-existence of physical and computer-generated elements in real-time. Its potential relies on the possibility of enhancing reality, making invisible things visible (Pastoor and Conomis, 2005) and sometimes, due to its synthetic nature, modifying the physical laws governing reality implementing diverse metaphors (visual, auditory and haptic) not available in the physical world (Ellis, 1994). A mixed-reality space can be built upon the dual-reality principle of reflecting actions between elements within a physical and virtual environment (Lifton 2007; 2009; 2010).

Systems are known in which a virtual object is generated that corresponds to a physical object in the real world. For example, cyber-physical systems (CPS) refers to systems with integrated computational and physical capabilities that bridge the cyber-world of computing and communications with the physical world (Rajkumar et al., 2010; Baheti and Gill, 2011). Embedded computers and networks monitor and control physical processes, usually with feedback loops where these processes affect computations and vice versa (Lee, 2008). CPS are usually implemented to monitor and control applications in physical and engineered systems using embedded computing. Information taken from the tangible world is based on physical variables (i.e. Temperature, humidity) and represented as two-dimensional (2D) abstract objects (e.g. Graphs, tables).

In the field of electronic gaming, gaming platforms are known that use tangible user interfaces (TUI) (Ishii and Ullmer, 1997) to augment the real physical world by coupling digital information to everyday physical objects and environments. Examples include game controllers, dance pads, sophisticated on-body gesture recognition controls such as Nintendo Wii or Ubisoft's Rocksmith.

In one such example, a real electric guitar is connected to a virtual interface in order to teach the end user to play the guitar in an individual learning session (or collaborative learning session if the other user has an extra electric guitar or electric bass). In such examples, a user can perform an action on a real object updating a state in the virtual world (e.g. a real string pressed is reflected on the virtual fret board and playing the sound).

Another example is known in which a virtual representation of a building is connected with physical sensors in the real world counterpart. Lifton (2007; 2009; 2010) used a bespoke sensor/actuator node as embedded in a power strip (called PLUG) to link virtual and physical worlds. This, sent the data collected to the virtual world, creating different metaphors that showed the data in real-time. Finally, multiple PLUGs were distributed within a physical building, creating a ubiquitous networked sensor/actuator infrastructure of interconnected nodes that reflected their current status on a virtual map of the building.

More advanced systems are described in Peña-Ríos et al, “Developing xReality objects for mixed-reality environments”, (Department of Computer Science, University of Essex, UK; Faculty of Computing and Information Technology, King Abdulaziz University, KSA.) which discussed the concept of “xReality” objects, and Peña-Ríos et al “Using mixed-reality to develop smart environments”, (Department of Computer Science, University of Essex, UK; Faculty of Computing and Information Technology, King Abdulaziz University, KSA.) which discusses “mixed-reality” techniques for use in everyday environments.

The examples of multidimensional spaces discussed so far represent different interactions between users/objects and the environment they belong, either virtual or physical. Unidirectional communication happens when actions from one environment are reflected in the other (affecting one or more users) but the feedback is not reciprocal. One example is the ISO/IEC 23005 standard specification, as it reflects haptic feedback based on actions happening in the virtual world, but it does not allow the modification of virtual environments (e.g. 4D movie), thus no dual-reality exists in such environments. Another example can be found in traditional TUIs (e.g. a joystick), where the action executed in the physical (e.g. pressing a button) has an effect in a virtual environment (e.g. a video game) and can be followed by all the players in the session, but an event in the virtual world would not modify the physical space. Moreover, such implementations try to create immersion in one (usually virtual) space only.

Bidirectional communications between virtual and physical worlds, involve the creation of blended-reality spaces where interaction happens in both worlds reflecting the changes in both. Those changes can be represented as 2D elements such as graphs or charts (e.g. smart home applications such as Samsung's Smart Home or the Phillips Hue system allow to change the physical status of objects via a software application) or metaphors (e.g. data pond at MIT's DualReality Lab). or mirrored to 3D virtual objects (e.g. VirCA project's virtual robot or the appliances at Essex' Intelligent Virtual Household). In these examples the relationship one-virtual object mirrored to one-physical object allows the creation of dual-reality states. A benefit of implementing these mirrored objects in collaborative environments with multiple users, is that the physical object can be remotely controlled via the virtual mirrored element. This represents an advantage for collaborative work between dispersed teams, where the use of specialised equipment might be restricted to specific geographical locations. However, none of these techniques provide a means for advanced mixed-reality systems to be readily implemented, particularly systems involving ad-hoc combinations of multiple real and virtual objects and multiple users, and systems capable of interacting independently of geographical location. Some limitations for the use of current shared physical-virtual object implementations are:
They have no possibility of modification or being regrouped into new shapes/services by end-users, or adding additional virtual/physical parts to change their configuration (i.e. Additional sensors/actuators).
They are configured to execute just particular actions, such as activate/deactivate single functionality (e.g. Switch on/off a light), limiting possibilities of collaboration and creation.
They represent either an object (e.g. a robot) or ambient variables (e.g. wind and lightening in a 4D movie) but not both.
Collaborative work in current implementations is represented only by remote users following the actions of the mixed-reality object via the virtual representation, or triggering a pre-programmed behavior as object's programming is done separately using traditional 2D GUI tools (e.g. LEGO's NXT programming IDE).
When the virtual world is used to connect two distant environments, there is only one physical object available in one of the environments.

### SUMMARY OF THE INVENTION

The present invention provides apparatus, systems and methods for interconnecting multiple distant learning environments, allowing bidirectional communication between environments, smart objects and users using a synchronising mechanism to mix distributed physical and virtual devices. The goal of this interconnected learning environment is to enable hands-on activities for distance learners based in a collaborative group-based learning session.

In accordance with certain aspects of the invention, a system is provided for generating at least one virtual object corresponding to at least one physical object, wherein the system is arranged to update the virtual object responsive to changes in state of the physical object, and the system is arranged to update the physical object responsive to changes in state of the virtual object.

In certain examples, the virtual object can be displayed to a user at a terminal remote from the real object. The user can manipulate the virtual object via the terminal, responsive to which, the system is arranged to control the state of the real object.

Mixes of real and virtual objects operate as a holistic system independently of geographical separation.

In certain examples, a deconstruction manager mechanism arranged to synchronise the physical object with the virtual object.

In accordance with certain aspects of the invention, a technique is provided which enables an advanced mixed-reality system to be implemented, for example, by the provision of a deconstruction manager. The mixed-reality system can support interactions with numerous users at numerous different locations.

In certain examples, the deconstruction manager comprises first functionality which identifies the physical object and the virtual object and further functionality which maintains characteristic information relevant for the physical object and the virtual object.

In certain examples, the deconstruction manager comprises a continuum manager mechanism arranged to identify the physical object and the virtual object from the first functionality and to identify characteristic information of the physical object and the virtual object from the further functionality, and the deconstruction manager is arranged to link the physical object with the virtual object, thereby enabling the physical object to be synchronised with the virtual object.

In certain examples, the deconstruction manager is implemented as software running on a server.

In certain examples, the deconstruction manager orchestrates the interaction of mixes of corresponding, or unique real objects and virtual objects to form a system that functions as a whole and independent of the distance separating the components.

In certain examples, the virtual object is displayed at a terminal remote from the physical object and a user can manipulate the virtual object via the terminal, responsive to which, the system is arranged to control the state of the physical object.

In certain examples, the system is arranged to generate further virtual objects, corresponding to further physical objects, each further virtual object being associated with one of the further physical objects.

In accordance with certain aspects of the invention, there is provided a server having software running thereon providing an instance of a deconstruction manager which is arranged to generate and maintain a virtual object associated with a physical object connected via a data connection to the server, said virtual object displayable on a mixed-reality graphical user interface of a user terminal connected to the server.

In certain examples, the deconstruction manager is arranged to synchronise the physical object with the virtual object.

In certain examples, the instance of the deconstruction manager communicates data to and from the physical object and the user terminal allowing a state of a controllable element of the physical object to be controlled via the mixed-reality graphical user interface of the user terminal.

In accordance with certain aspects of the invention, there is provided a system for enabling mixed-reality interaction. The system comprises at least one physical object corresponding to at least one virtual object, said physical object responsive to changes in state of the virtual object, and said virtual object responsive to changes in state of the physical object; a server that manages communication between the physical object and virtual object, and a graphical user interface that enables input to be received from users in remote locations to change the status of the physical object and virtual object and to combine the physical object and virtual object.

In accordance with examples of the invention, a technique is provided that enables given instances of a shared reality to be dynamically set and managed thereby creating user and machine adjustable virtuality. For example, this includes supporting the mixing of physical and virtual components (that may or may not correspond to each other). In other examples certain embodiments would enable eLearning to be extended from “on-screen” collaborative activities (e.g. problem solving, concept formation, etc.) to include off-screen activities constructing physical devices such as those associated with engineering laboratories (e.g. collaboratively building physical internet-of-things devices via users and systems that are geographically dispersed, etc.)

In contrast to prior art systems and techniques, dynamic-reality partition management is provided (i.e. maintenance of adjustable multi state, user and multi information flows) which enables possibilities for creation by enabling the combination and use of disaggregated services/functions into new functionalities created by end-users.

### BRIEF DESCRIPTION OF FIGURES

Certain embodiments of the present invention will now be described hereinafter, by way of example only, with reference to the accompanying drawings in which:

FIG. 1 provides a simplified diagram of a system for implementing a simple example of a mixed-reality system;

FIG. 2a provides a simplified schematic diagram illustrating the concept of the implementation of a deconstruction management engine;

FIG. 2b provides a schematic diagram providing a more detailed view of certain components of a Reality Continuum Deconstruction Manager;

FIG. 3 provides a simplified schematic diagram of a mixed-reality system comprising a plurality of real objects;

FIG. 4 provides a schematic diagram illustrating the concept of creating a new synchronised virtual-physical object;

FIG. 5 provides a schematic diagram illustrating the concept of a virtual-physical object that is synchronised across two or more physical environments;

FIG. 6 provides a schematic diagram illustrating the concept of creating prototypes between dispersed teams;

FIGS. 7 and 8 provide schematic diagrams of a mixed-reality smart learning model as a computational architecture;

FIG. 9 provides a schematic diagram of components of a blended-reality space;

FIG. 10 provides a schematic diagram illustrating the concept of connecting multiple separated physical spaces linked to a common virtual space;

FIG. 11 provides a schematic diagram illustrating four conceptual layers of an interreality portal;

FIG. 12 provides a schematic diagram illustrating the conceptual construction of xReality objects and the differences between them, physical objects, and virtual objects;

FIG. 13 provides a schematic diagram depicting the synchronisation in real-time between physical objects and their virtual representations;

FIG. 14 provides a schematic diagram showing the conceptual model of a complete InterReality system composed by an InterReality Portal and one xReality object;

FIG. 15 provides a schematic diagram showing the connection between two InterReality systems;

FIG. 16 provides a schematic diagram showing the possible configurations of a single and multiple xReality objects in a shared virtual environment, regardless of their physical location;

FIG. 17, corresponding to FIG. 4, provides a schematic diagram depicting a one to one relationship between a physical object and virtual object creating a local blended-reality environment;

FIG. 18, corresponding to FIG. 5, provides a schematic diagram depicting an extended blended-reality environment in which a physical object is reflected in the virtual environment and linked using its virtual entity to another object in a remote space;

FIG. 19, corresponding to FIG. 6, provides a schematic diagram depicting an analogy of a puzzle in which different participants have one or more pieces that allow the completion of a final object inside a virtual world;

FIG. 20 provides a schematic diagram of a scenario comprising two or more xReality objects that do not complement each other and exist as separate entities inside a common virtual space;

FIG. 21 depicts a scenario in which two users are collaborating in the creation of a clock alarm;

FIG. 22 provides a schematic diagram illustrating the concept that the more xReality objects used in a shared environment, the less simulated the environment;

FIG. 23 provides a schematic diagram depicting a general classification of learning activities within the mixed-reality smart learning framework, and

FIG. 24 provides a schematic diagram depicting activities of the mixed-reality smart learning framework available within a proposed InterReality system.

### DETAILED DESCRIPTION

In the drawings like reference numerals refer to like parts.

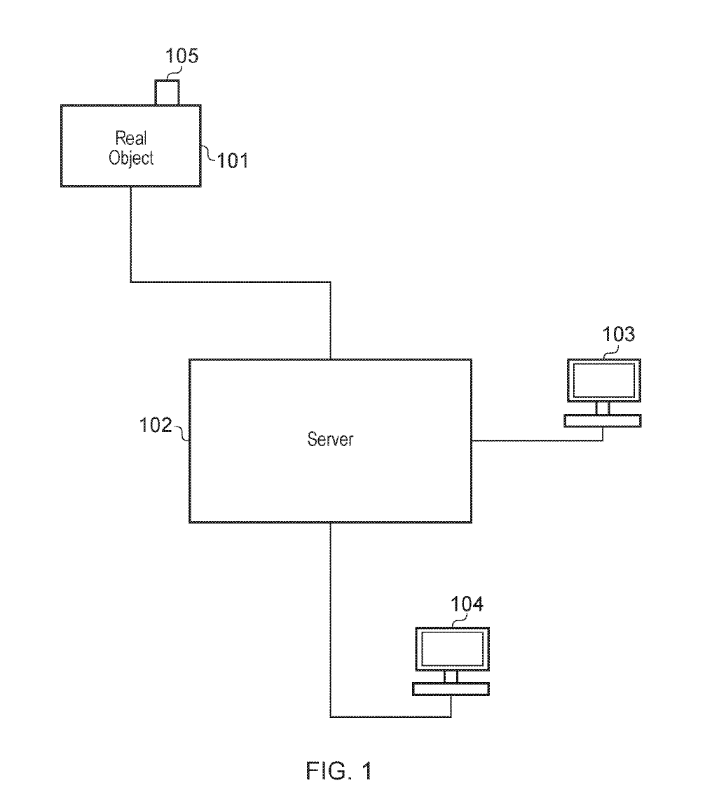

FIG. 1 provides a simplified diagram of a system for implementing a simple example of a mixed-reality system.

A real object 101 is connected, via a data connection, to a server 102. The server 102 is further connected to a plurality of user terminals 103, 104. Each user terminal 103, 104 includes a display means (e.g. a monitor) and user input means (e.g. a mouse and keyboard). The real object 101 includes a controllable element 105 (e.g. a light) which can be controlled by a control mechanism on the real (i.e. physical) object 101. Further, information about the state of the controllable element 105 of the real object 101 is communicated from the real object 101, for example via the control mechanism, to the server 102.

The server 102 includes thereon software arranged to generate and maintain a virtual representation of the real object 101, referred to as a “virtual object”. The “virtual object” may graphically correspond to the real object 101, including, for example reflecting the current state of the controllable element 105 (e.g. whether the light is on or off). The server 102 is arranged to communicate data corresponding to the virtual object to the user terminals 103, 104. The user terminals 103, 104 are arranged to display the virtual object on a mixed-reality graphical user interface (GUI). The mixed-reality GUI is arranged to allow a user of a user terminal to manipulate the virtual object via the user input means, for example manipulating the controllable element 105 (e.g. turning the light on or off). The user terminal is arranged to communicate manipulation data corresponding to this manipulation of the virtual object back to the server 102. The software running on the server 102 is arranged to convert the manipulation data into control data and communicate this to the real object 101. The real object 101 includes means to use the control data (for example the control mechanism described above) to control the controllable element in accordance with the manipulation of the virtual object performed by the user of the user terminal (e.g. turn the light on or off).

In this way a number of users who may be physical separated can use a mix of a physical and virtual environment to collaborate together to control a real object. Real objects that can be connected to a network and controlled in this way are referred to as “smart objects”.

The arrangement described with reference to FIG. 1 is greatly simplified. In certain examples, considerably more advanced mixed-reality systems are envisaged, with multiple real objects, with many complex controllable elements. Such an advanced mixed-reality system can be used for collaborative activities such as education and training.

In order to facilitate such advanced systems, a mechanism can be provided that dynamically allocates and manages deconstruction and reconstruction of mixed-reality partitions.

Such a mechanism can serve as a component of advanced collaborative online systems such as those in education (e.g. mixed-reality engineering labs), training (e.g. surgery, flight, repair), field servicing (e.g. fixing of field faults through mixed reality mirroring and presence), games (e.g. dual-reality gaming) or business (e.g. multi-national R&D).

Fundamentally all realities are composed of combinations of mixes of (low-level) physical and virtual components. The challenge for creating any particular variation is how to manage the deconstruction, reconstruction and maintenance of the system across the different realities.

Typically, electronic computer systems are constructed from a combination of networked components (extending from high-level holistic systems down to low-level sub-systems). Likewise, learning comprises combinations of lower level skills/knowledge.

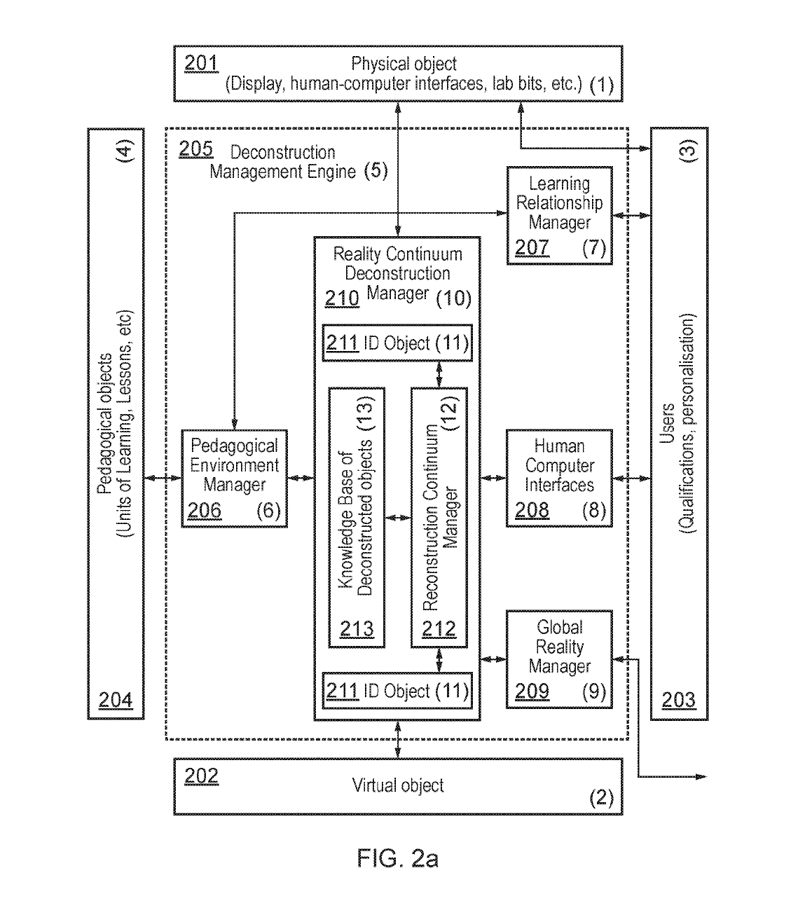

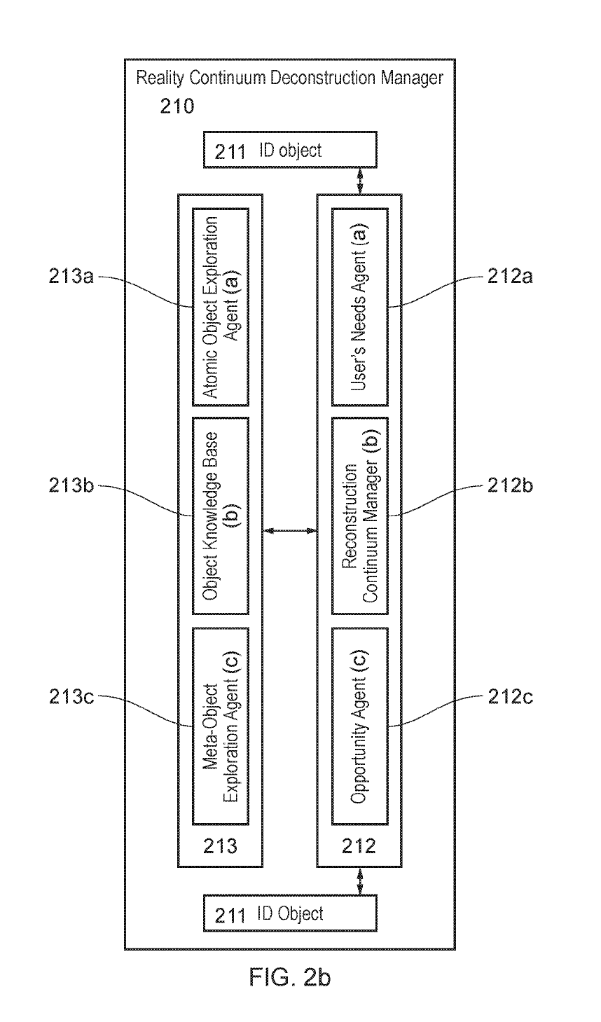

It has been recognised that both computers and education could be viewed as a deconstruction and reconstruction of these basic elements. Accordingly a “deconstruction management engine” that enables various realities to be created and managed to meet the needs of users has been provided. This concept is illustrated in FIG. 2a.

FIG. 2a provides a simplified schematic diagram illustrating the concept of the implementation of a deconstruction management engine.

FIG. 2a illustrates a representation of physical objects 201, implemented, for example, using smart objects with network capabilities that can be connected to the proposed system; virtual objects 202, created as 3D representations of the physical objects 201; users' profiles 203, which contain user information and can be used for personalisation of the environment; pedagogical objects 204, which can be used in combination with virtual objects 202 and physical objects 201 to create learning activities.

FIG. 2a further shows a Deconstruction Management Engine 205, which is the mechanism that manages all the elements in the environment.

The Deconstruction Management Engine 205 includes a Pedagogical Environment Manager 206, a Learning Relationship Manager 207, a Human Computer Interfaces (HCI) module 208, a Global Reality Manager 209 and a Reality Continuum Deconstruction Manager 210.

The Pedagogical Environment Manager 206 is a mechanism that manages the pedagogical objects 204, combining them into learning activities that will be undertaken by the users, and linking those pedagogical objects 204 to the mixed-reality objects involved in the lessons.

The Learning Relationship Manager 207 controls users' preferences and aptitudes matching them to pedagogical objects via the Pedagogical Environment Manager.

The Human Computer Interfaces (HCI) module 208 is a high-level representation of different interfaces that can interact with the wider model (e.g. mobile devices, mixed-reality platforms, desktop interfaces, etc.).

The Global Reality Manager 209 is a module that interconnects multiple remote implementations of the Deconstruction Management Engine.

The Reality Continuum Deconstruction Manager 210 is the mechanism that identifies, interconnects and synchronises physical and virtual objects.

Deconstruction Manager 210 includes an ID object element 211, a Reconstruction Continuum Manager 212 and a Knowledge Base of Deconstructed Objects 213.

The ID object element 211 is an element that allows identification of the objects (virtual and physical).

The Knowledge Base of Deconstructed Objects 213, contains the information relevant for each object either virtual or real.

The Reconstruction Continuum Manager 212 is the mechanism that identifies the objects and their characteristics using information from the knowledge base of deconstructed objects, creating a link between objects, and keeping their statuses updated and synchronised.

FIG. 2b provides a schematic diagram providing a more detailed view of certain components of the Reality Continuum Deconstruction Manager 210.

As can be seen from FIG. 2b, the Knowledge Base of Deconstructed Objects 213 comprises three subunits. Specifically, an Atomic Object Exploration Agent 213a, an Object Knowledge Base 213b, and Meta-Object Exploration Agent 213c.

The Atomic Object Exploration Agent 213a is representative of a function that performs a process that is responsible for: (1) discovery of atomic elements; (2) consistency checks between the real world and the knowledge base representation, and (3) adding unique atomic elements to the database. Typically, the process is technology agnostic, allowing operation with a diverse range of devices.

The Object Knowledge Base 213b is representative of a function that contains a record of objects known by the system and which describes their properties.

Meta-Object Exploration Agent 213c is representative of a function that performs a process that pro-actively searches for (1) atomic elements with similar properties, (2) atomic elements with complementary properties, (3) atomic elements that have been previously combined.

Further, as can be seen from FIG. 2b, the Reconstruction Continuum Manager 212 comprises three subunits. Specifically, a User's Needs Agent 212a, a Reconstruction Manager 212b, and an Opportunity Agent 212c.

The User's Needs Agent 212a is representative of a function that performs a process that accepts the learning needs via the pedagogical environment manager in order to identify suitable objects to meet the learning goals.

The Reconstruction Continuum Manager 212b is a function that performs a process that provides a mechanism that identifies the objects and their characteristics using information from the Knowledge Base of Deconstructed Objects 213 creating a link between objects and keeping their statuses updated and synchronised.

The Opportunity Agent 212c is a function that performs a process that provides suggestions based on the outcome of the Meta-Object Exploration Agent 213c. This process can also works in reverse where learning needs can drive the meta-object exploration activity.

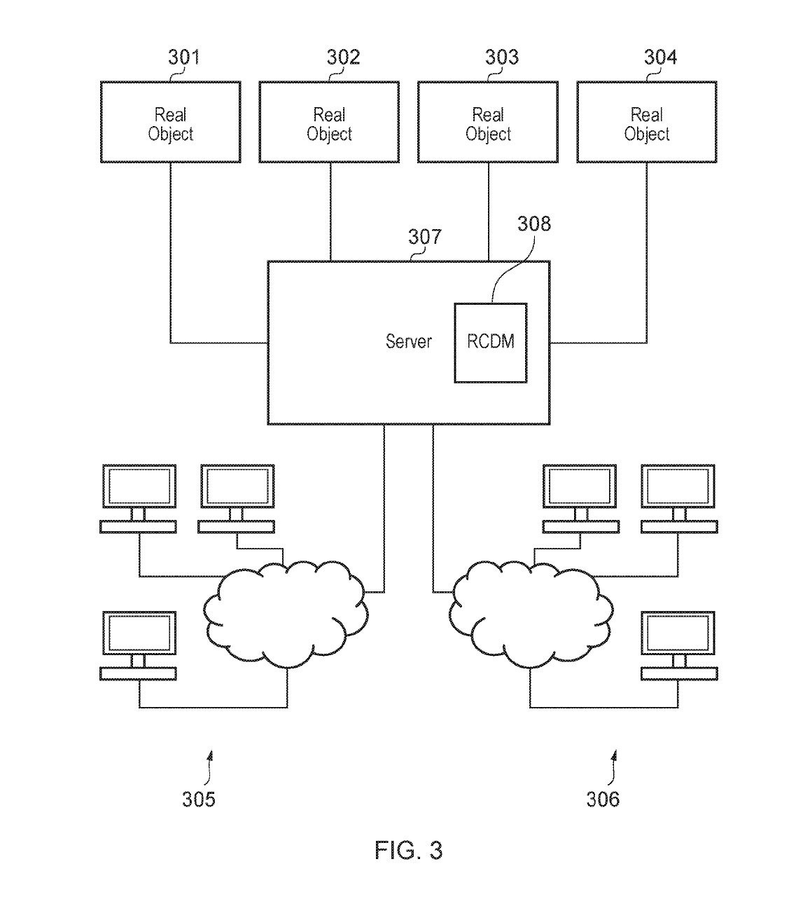

In certain examples of the invention, an instance of the Reality Continuum Deconstruction Manager 210 can be implemented as software running on a server. FIG. 3 provides a schematic diagram illustrating this.

FIG. 3 provides a simplified schematic diagram of a mixed-reality system which corresponds to that depicted in FIG. 1 except that it comprises a plurality of real objects 301, 302, 303, 304 and a plurality of groups of user terminals 305, 306. The groups of user terminals are positioned in different geographical locations. The real objects 301, 302, 303, 304 each include multiple controllable elements.

A server 307 has running thereon software which is arranged to generate and maintain virtual objects associated with the real objects 301, 302, 303, 304. As described with reference to FIG. 1, user terminals of the groups of user terminals are arranged to display these virtual objects and to allow users to control aspects of the controllable elements of the real objects by manipulating the virtual objects via a mixed-reality GUI.

In order to facilitate the operation of the system shown in FIG. 3, and in particular the operation of the server 307, as described above, the software running on the server 307 includes an instance of the Reality Continuum Deconstruction Manager 308.

The Reality Continuum Deconstruction Manager 308 ensures that the real objects (e.g. the states of the controllable elements of the real objects) remain synchronised with the representation of the real objects (i.e. the virtual objects). This is achieved, at least in part, by an ID object element of the Reality Continuum Deconstruction Manager 308 allowing the real objects 301, 302, 303, 304 and the corresponding virtual objects to be identified, by a Knowledge Base of Deconstructed Objects of the Reality Continuum Deconstruction Manager 308 containing relevant information about each virtual object and each real object, and Reconstruction Continuum Manager of the Reality Continuum Deconstruction Manager 308. The Reconstruction Continuum Manager combines information from the ID object element and the Knowledge Base of Deconstructed Objects to create a link between the real objects and virtual objects, and keep their statuses updated and synchronised.

As will be understood, the Reality Continuum Deconstruction Manager 308 typically operates during initialisation and operation of the mixed-reality system shown in FIG. 3.

For example, if a real object (e.g. any smart object with network capabilities) is connected to a local network (e.g. connected to a system such as that illustrated in FIG. 3), it sends a request with its Object ID to the Reconstruction Continuum Manager (RCM), which searches for the object in the Knowledge Base of Deconstructed Objects (KBDO). If the object is recognised by the KBDO then information about its virtual correspondent object is sent back to the RCM. The RCM is then arranged to:
A. Link the physical object to a new instance of its correspondent virtual object, or
B. Link the physical object with an existing virtual object inside the 3D virtual world.

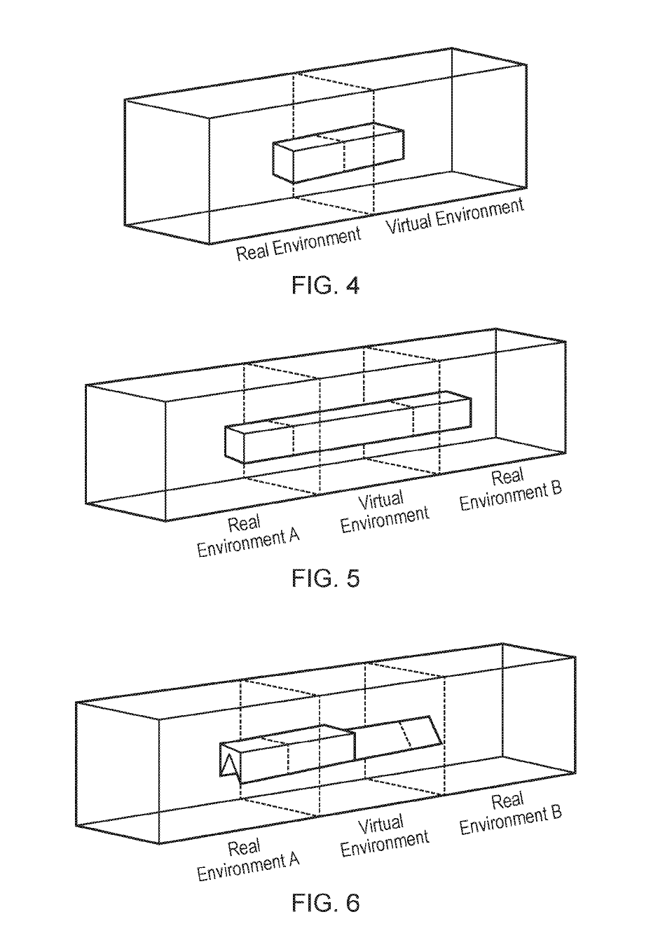

Option A creates a new synchronised virtual-physical object (referred to as an “xReality” object). This concept is illustrated in FIG. 4.

Option B creates a virtual-physical object that is synchronised across two or more physical environments. This concept is illustrated in FIG. 5.

Finally, by having a number of xReality objects, they can be combined in the virtual world, forming a new composite object. This object can be used for the creation of prototypes between dispersed teams, as each real environment would have one part of the mashup (e.g. sensors in one side of the environment and displays in the other side). This concept is illustrated in FIG. 6.

After doing an extensive literature review on current shared physical-virtual object implementations, some limitations that it was possible to identify are:

In contrast to techniques facilitated by certain embodiments of the invention, prior art techniques typically provide no possibility of allowing xReality objects to be modified, regrouped into new shapes/services by end-users, or added to by additional virtual/physical parts to change their configuration (e.g. additional sensors/actuators).

In contrast to techniques facilitated by certain embodiments of the invention, prior art techniques are typically configured only to execute just particular actions, such as activate/deactivate single functionality (e.g. switch on/off a light, moving from A to B in the case of the robots), limiting possibilities of collaboration and creation. For example, prior art techniques may be restricted to represent either an object (e.g. a robot) or ambient variables (e.g. wind and lightening in a 4D movie) but not both.

Typically, in contrast to techniques facilitated by certain embodiments of the invention in prior art techniques, collaborative work is represented only by remote users following the actions of the mixed-reality object via the virtual representation, or triggering a pre-programmed behaviour as, typically, an object's programming is done separately using traditional 2D GUI tools (e.g. LEGO's NXT programming IDE). Typically, in prior art techniques, when the virtual world is used to connect two distant environments, there is only one physical object available in one of the environments.

As will be understood, various components of the Deconstruction Management Engine depicted in FIG. 2a, for example the Pedagogical Environment Manager 206, the Learning Relationship Manager 207, the Human Computer Interfaces (HCI) module 208, the Global Reality Manager 209 and the Reality Continuum Deconstruction Manager 210 are, in some examples, logical designations. Thus the functionality associated with these components can be implemented in any suitable way. For example as one or more mechanism (hardware or software) operating on separate components of the mixed-reality system, or via some shared mechanism such as part of one or more networked computers or servers.

It will be understood that in certain examples, there is not necessarily a one to one correspondence between real objects and virtual objects.

The following explains further concepts from the background art, and further explains concepts associated with implementation of certain embodiments of the invention.

### Frameworks and Conceptual Models (Architectural and Pedagogical)

The use of technology in education poses many challenges, especially to distance learners who often feel isolated and experience lack of motivation in completing on-line activities. The challenge is bigger for students working on laboratory based activities, especially in areas that involve collaborative group-work involving physical entities. Embodiments seek to create a learning environment based on collaborative multidimensional spaces, able to connect learners in different geographical locations and foster collaboration and engagement.

In the following a conceptual and architectural model is introduced for the creation of a learning environment able to support the integration of physical and virtual objects, creating an immersive mixed-reality laboratory that seamlessly unites the working environment of geographically dispersed participants (teachers and students), grounded on the theories of constructionism and collaborative learning.

### Mixed-Reality Smart Learning Model (MiReSL)

The shift from classroom instruction to ubiquitous student-centred learning has provided a number of technology-based platforms designed to enhance the learning ecosystem; understanding ecosystem as “the complex of living organisms, their physical environment, and all their interrelationships in a particular unit of space” (Encyclopaedia Britannica, 2015). This vision goes from complete campus implementations, considering educational, administrative and social aspects such as the one introduced by Ng et al. (2010); to specific setups designed for specific stakeholders.

Gü tl and Chang (2008) analysed diverse approaches focused on the learning process itself, identifying important aspects which need to be considered in technology-based learning environments:
A contextual and timely approach able to change, facing learner requirements (Burra, 2002) (adaptable).
Social and cultural aspects (Bransford et al., 1999).
Learning community aspects as well as learner-centred, knowledge-centred and assessment-centred aspects (Bransford et al., 1999) (collaborative).
Individual learner profiles which include task and role-based aspects, interests, knowledge state, short-term learning objectives and long-term career goals (Ismail, 2002; Gu\ddot{}tl, 2007) (personalised).

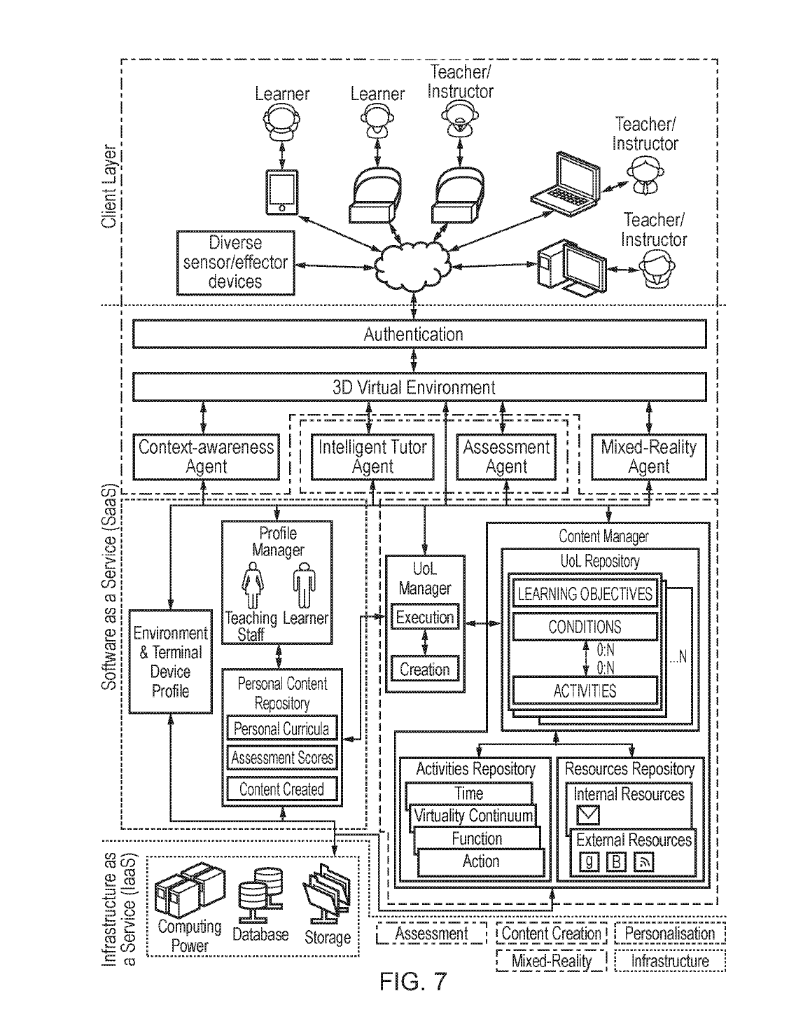

For a mixed-reality learning environment, context-aware technology should also be considered that is able to identify users, objects, and the physical environment. The Mixed-Reality Smart Learning (MiReSL) model is discussed below, which is a conceptual architectural model. The MiReSL model incorporates a Smart Learning approach (u-learning with a cloud computing infrastructure) with the (De)constructed model of components for teaching (Units of Learning) and learning (physical and virtualised objects) to deliver personalised content enhanced with co-creative mixed reality activities that support the learning-by-doing vision of the constructionist approach. FIG. 7 presents MiReSL as a computational architecture, which can be divided in four main characteristics:
A personalised learning environment, which keeps track of profiles, preferences, personal scores and learning objectives. Is formed by: a) a Profile Manager, which ensures the integrity of sessions, managing privileges and settings for the environment according to user preferences and roles available (student or instructor); and b) a Personal Content Repository, which maintains the Personal Curricula (all the units of learning assigned or self-selected by the user), the Assessments Scores, and any Content Created. Additionally, it stores information about the learning environment and configuration (needed by the Context-Awareness Agent) in the Environment and Terminal Device Profile.
Content creation, allowing instructors to design and create units of learning (UoL) maintained by the Content Manager in the UoL repository. A unit of learning is composed of at least one activity, which in turn, is formed by a number of Learning Objects (LO), which can be any internal (e.g. internal messaging system, internal e-mail, etc.) or external resources (e.g. web search engines, blogs, rss, etc.) located in their correspondent repository.
Assessment of the UoLs, providing feedback and helping to create personalised content suitable for the learner. It is formed by an Intelligent Tutor Agent and an Assessment Agent. The Intelligent Tutor Agent evaluates and suggests new content to the learner based on the feedback received by the Assessment Agent and other variables such as frequency and time dedicated to study, and user preferences. The main objective of this agent is to act as a facilitator, supporting and guiding the learners as they acquire knowledge. The Assessment Agent is the one that evaluates the activities according based on the learning objectives defined on each UoL.
The mixed-reality aspect involves the creation of the mixed-reality learning environment, understood as the human-computer interface (HCI) that allows learners to interact with a mix of physical and virtual objects to achieve specific learning goals. It comprises the Context-Awareness Agent, which obtains real-time information of interactions between elements in the environment (i.e. users, objects, or the environment itself), and passes the information to the Mixed Reality Agent, which process changes on the environment and reflects them in their respective scope. It includes an authentication module and the 3D user interface which allows communication and collaboration between users when performing the mixed-reality learning activities.

Finally, the model is supported by a highly-available technological infrastructure based on cloud computing which provides benefits such as: a) the possibility to store, share and adapt resources within the cloud, b) increased mobility and accessibility, c) and the capacity to keep a unified track of learning progresses, d) the use of resources such as synchronous sharing and asynchronous storage allows the model to be available at any moment that the student requires (Kim et al., 2011; Sultan, 2010).

### A Distributed Blended-Reality Framework

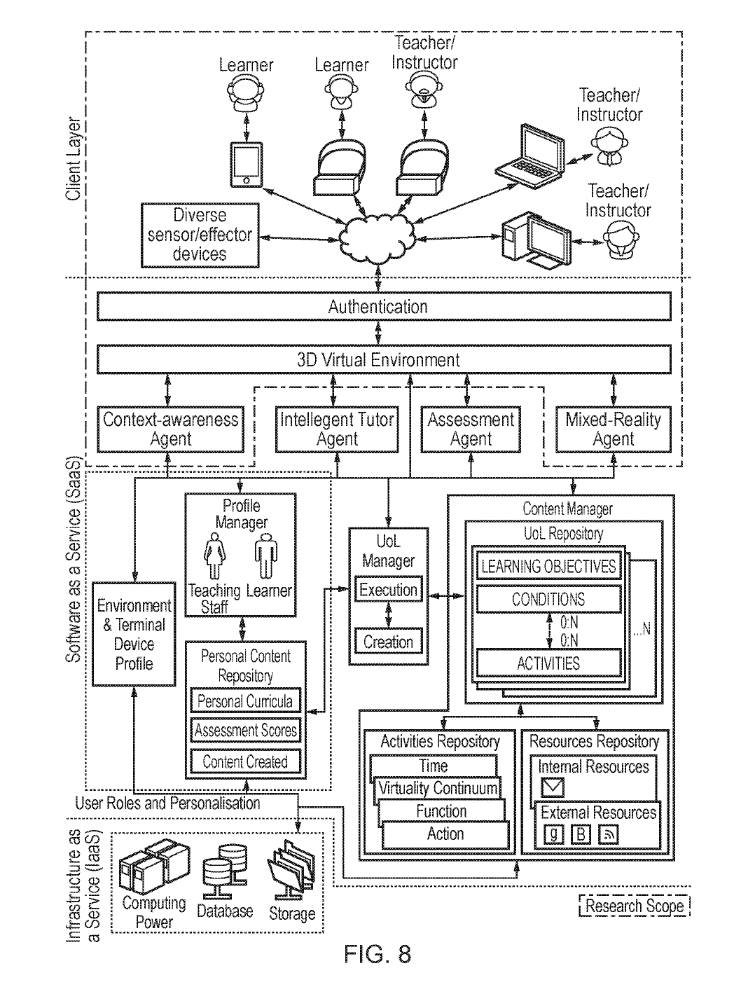

The MiReSL Model is proposed as a complete ecosystem for the use of mixed-reality in learning. The MiReSL model described has been used as a reference point at the Immersive Education Lab Research Group at the University of Essex (Alrashidi et al., 2013; Alzahrani et al., 2015; Felemban, 2015). FIG. 8 shows the areas described at the original MiReSL.

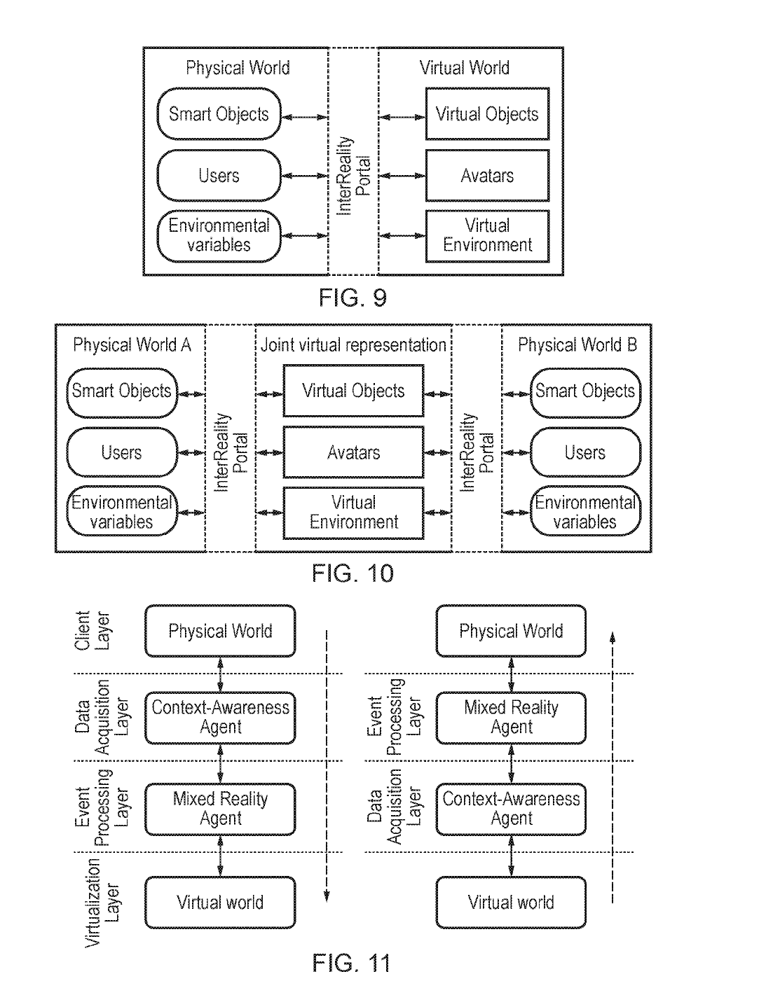

Based on this strategy, a model is proposed for interconnecting multiple distant learning environments, allowing bidirectional communication between environments, smart objects and users using a synchronising mechanism to mix distributed physical and virtual devices. The goal of this interconnected learning environment is to enable hands-on activities for distance learners based in a collaborative group-based learning session. FIG. 9 illustrates the three components of a blended-reality space:
a) The physical world, where the user and the physical objects are situated;
b) The virtual world, where the physical-world data will be reflected using 3D virtual objects, allowing multiple users/environments to be interconnected;
c) The Interreality Portal, a human-computer interface (HCI) which receives and processes in real-time data generated by the physical environment, so it can be mirrored by its virtual counterpart. The fundamental task of the InterReality Portal is to detect changes in one environment and translate them into appropriate actions within the other environment.

A blended-reality space can be built upon the dual-reality principle of reflecting actions between elements within a physical and virtual environment. FIG. 9 shows the correspondent mappings to link one physical environment with one virtual environment via the InterReality Portal (i.e. smart objects with virtual objects, users with avatars, and environmental variables with a virtual environment). Smart objects are used for two main reasons: a) its capability to sense and interpret their local situation and status, and b) its ability to communicate with other smart objects and interact with human users. Thus, if an object changes its state either in the physical or the virtual world, the change is immediately reflected in its mirrored object, linking both worlds in real-time; for example, turning on a network-controllable household device (e.g. a TV) would turn on its linked virtual representation (e.g. a 3D virtual object simulating a TV). Similarly, users could be linked to their avatars via wearable devices; tracking physical characteristics such as geographical location, or even emotions via physiological measurements (e.g. heart rate, PH level, etc.) and translating them to their virtual persona (avatar). In this mapping, clearly a change executed in an avatar cannot change the user physical appearance or physiological characteristics, but it could be reflected using multimodal feedback via the wearable device (e.g. a haptic response).

Finally, environmental variables within the physical space (i.e. temperature, humidity, light level, etc.) could be captured via networked sensors and reflected in the virtual environment in multiple ways, for example, the value of a light sensor can be mapped to the sun within the virtual world, creating virtual sunsets and sunrises synchronised with the ones in the physical world. A change in the virtual world cannot be directly reflected in the physical environment (e.g. we cannot change the sun position at will), but the change could be translated using diverse actuators within a closed physical smart environment (i.e. a smart room). FIG. 9 describes the connection between one physical space with one virtual space only, however, it could be possible to connect multiple separated physical spaces, linking them to a common virtual space by interconnecting and synchronising their elements, creating the illusion of one common extended space as shown in FIG. 10.

Embodiments relate to synchronisation between objects and environmental variables across multiple dual-reality spaces. Embodiments relate to the creation of a distributed blended-reality space able to allow users in different locations interact and share objects, extending the spaces to allow them to work in collaborative hands-on learning activities.

The following introduces the proposed mixed-reality learning environment, the InterReality Portal, and the distributed architecture of interconnected portals that allow learners in geographically distributed locations work in collaboration, creating a large-scale education environment.

### The InterReality Portal

The InterReality Portal can be defined as a collection of interconnected physical and virtual devices that allow users to complete activities between the two extreme points of Milgram's Virtuality Continuum. From the educational point of view, and inspired in Callaghan (2010a) Science Fiction Prototype (SFP), it can be defined as a mixed-reality learning environment that allows remote students to do activities together using a mixture of physical and virtual objects, grounded on the learning-by-doing vision of constructivism. It is conceptually formed by four layers (FIG. 11):
The Client layer or physical world, which refers to the physical environment where the learner, the physical object(s) and environmental variables exist.
The Data Acquisition layer, which is responsible for obtaining real-world information based on network eventing data produced by interactions between:
   a) the user and the physical objects, or
   b) the user and the physical environment.
The Event processing layer, which retrieves a set of rules and actions (behaviours) available for the particular object/environment. These rules and actions determine the result in either the physical or the virtual environment, triggered by an interaction.
Finally, the Virtualisation layer contains the 3D virtual environment, 3D virtual object(s) and avatar(s).

To link and synchronise physical and virtual worlds, any interaction/change in the physical world is identified by the Context-Awareness agent (CAag) (in the data acquisition layer); and sent to the Mixed-Reality agent (MRag) (in the event processing layer). Then, the Mixed-Reality agent (MRag) executes a correspondent action on the 3D virtual environment based on the behaviours available for that particular action and reflecting any changes accordingly. Similarly, changes from virtual to physical, are detected by the CAag and passed upon to the MRag, which sends the correspondent behaviour to the physical object (FIG. 11), achieving bi-directional communication based on mirrored dual-reality states.

xReality Objects

Cross-reality (xReality) objects are smart networked objects coupled to their virtual representations, updated and maintained in real time within a mixed-reality space. The difference between smart objects and xReality objects is that the digital representation of the latter emulates the shape, look and status of the physical object in a 3D virtual environment, and allows bidirectional updates; whereas the digital representation of a smart object, if implemented, is commonly represented as a 2D graphic or table in a graphical user interface (GUI).

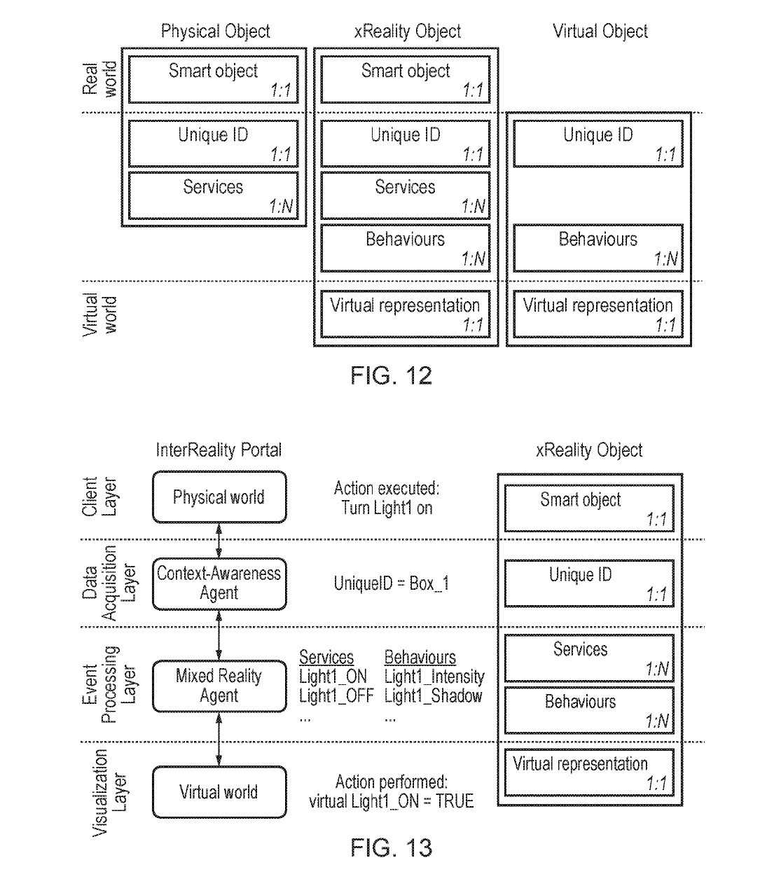

FIG. 12 shows the conceptual construction of xReality objects and the differences between them, physical objects, and virtual objects. Physical smart objects have a unique ID, and a list of minimum one available service; understanding as services all the properties inherent to the particular object (e.g. in the case of an internet-controllable lamp, its available services could be turned on and turned off). In a similar way virtual objects have a unique ID and one or more behaviours attached (e.g. in the case of a virtual light, its available behaviours could be light intensity and light shadow). Thus, xReality objects take characteristics of both objects, correlating them to synchronise physical and virtual worlds simultaneously.

The synchronisation in real-time between physical objects and their virtual representations is exemplified in FIG. 13. Here, where an action is executed in a smart object within the physical world (e.g. turn Light1 on), the change is detected by the Context-awareness agent (CAag), which proceeds to: a) identify the object via its unique ID (e.g. UniqueID=Box 1), and b) send this information to the Mixed Reality (MRag) agent. The MRag determines which is the behaviour linked to that change in the smart object, and proceeds to update the virtual object (e.g. turn virtual Light1 on) in the visualization layer, and thus synchronising virtual with physical elements of a xReality object and creating a one-to-one interaction, which can be defined as a single dual-reality interaction. Therefore, in this example, every time the physical light changes its state, the InterReality portal reflects this change in its virtual counterpart, and vice versa, linking and synchronising both objects in real-time.

Managing Multiple xReality Objects

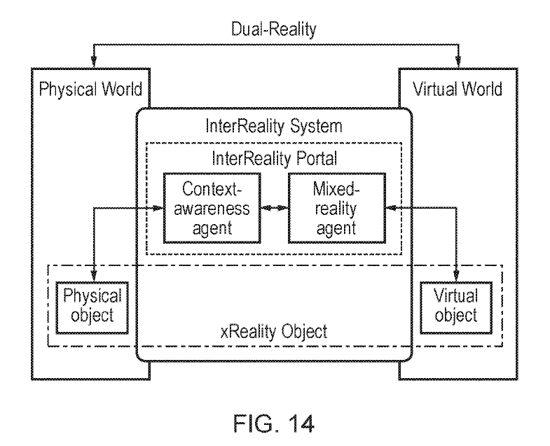

As described in the previous section, the synchronisation between one physical object and one virtual object, creates a mirrored xReality object that exists in both worlds simultaneously; this real-time synchronisation that allows object's existence in both worlds is defined as a dual-reality state. FIG. 14 shows the conceptual model of a complete InterReality system composed by the InterReality Portal and one xReality object. The diagram illustrates a one-to-one relationship between one physical object and one virtual object in a local mixed-reality space; however, when connecting a second InterReality system in a remote mixed-reality space, it is necessary to manage multiple dual-reality states.

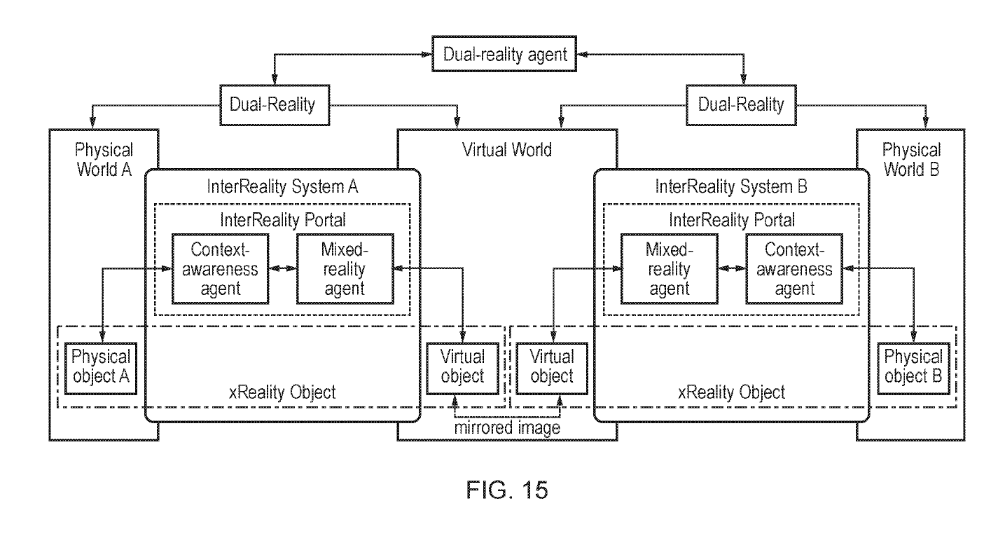

FIG. 15 shows the connection between two InterReality systems. Here, the Context-awareness agent (CAag) periodically requests information from the physical object to identify any change on the object, when a change is detected the information is sent to the Mixed-reality agent (MRag) which translates this as an action in the virtual object. When this process is replicated on a second InterReality system, the Dual-reality agent (DRag) coordinates the synchronisation between multiple environments following these predefined rules (Pena-Rios et al., 2012b):
1. A change in a virtual object of a given InterReality system results in identical changes to all mirrored virtual objects in any subscribing InterReality portal.
2. A change in a physical object of a given InterReality system results in changes to the virtual representation of the physical device in all subscribing Inter-Reality portals; and in changes to the physical objects linked to those virtual representations. Therefore, a change in a physical object “A” is reflected first in its linked virtual representation within the local InterReality system; and then sent via the Dual-reality agent to any remote InterReality system connected at that time. The remote InterReality system first reflects the change in the virtual representation, and then changes the status in the physical object “B”. When this mechanism is replicated using multiple xReality objects in each physical space, it is possible to mirror distant physical spaces and thus joining multiple distant environments based on a distributed mixed-reality architecture.
   Interactions within Distributed Mixed-Reality Collaborative Environments

The possibility of having multiple xReality objects in a distributed mixed-reality architecture introduces different scenarios for collaboration between distant users.

Moreover, it allows the creation of mashups between local xReality objects and distant xReality objects, or the interaction between complete xReality objects (understanding them as a physical object linked to its virtual representation) with virtual objects without links to a physical object.

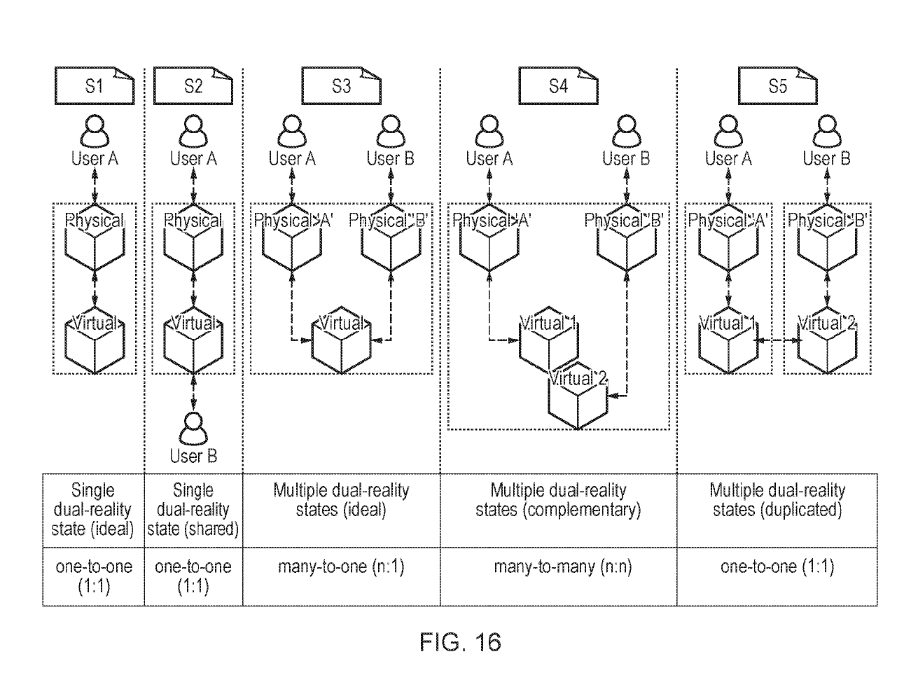

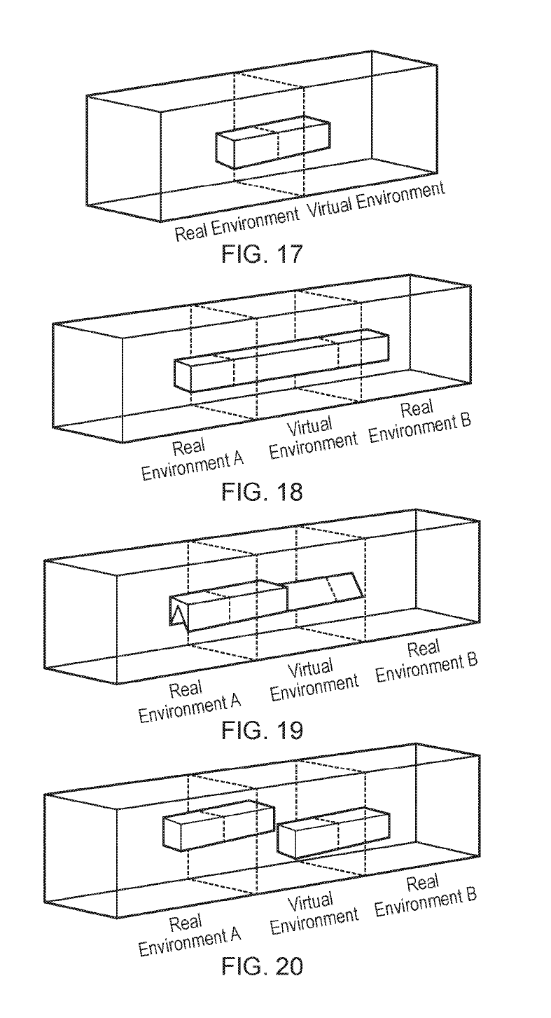

Scenario S1 in FIG. 16 shows a single xReality object owned by one user in a local environment. This represents an ideal single dual-reality relationship, which is formed by the synchronisation between one physical object (situated in the local environment) and one virtual object (described as a one-to-one relationship). It is this one-to-one relationship which creates a local blended-reality environment (FIG. 17).

When an additional user joins, he/she can interact with the remote physical object via the shared virtual representation (scenario S2); or via a local object linked to the same virtual representation (scenario S3), creating a many-to-one relationship (many physical objects connected to one virtual representation). The relationship between physical and virtual objects described in scenario S3 represents an extended blended-reality environment (FIG. 18), in which an element is reflected in the virtual environment and linked using its virtual entity to another object in a remote space, showing a continuous shared element within spaces (real-virtual-real) with multiple dual-reality states.

The scenarios described so far use only one physical object in the local environment or one in both, the local and the remote space; however, when adding more physical objects to each environment it is possible to create mashups between multiple xReality objects. Scenario S4 describes a collaborative session where users combine xReality objects that physically exist in the owner's local environment, but can be shared and combined using its virtual representation in the virtual world, creating a complete new object in the virtual. As an analogy, this can be seen as a puzzle where each of the participants have one or more pieces that allows the completion of the final object inside the virtual world (FIG. 19).

Finally, scenario S5 shows the possibility of having two or more xReality objects that do not complement to each other, but instead, both exist as separate entities inside the common virtual space (FIG. 20).

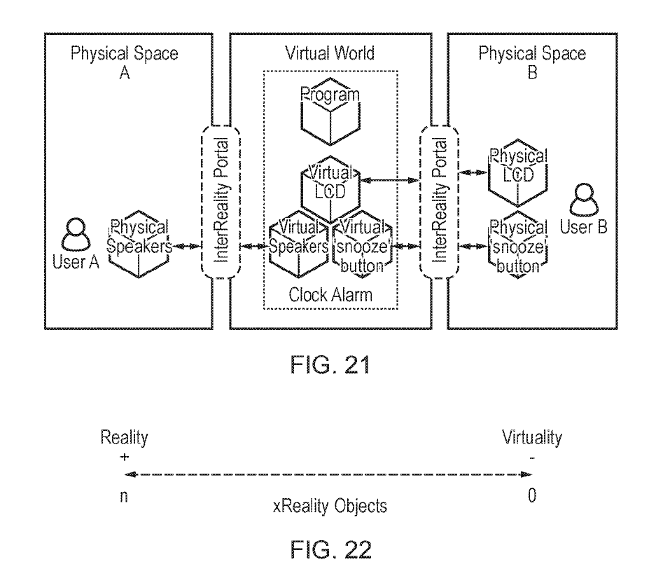

By way of an illustration of the different combinations that can be used to create a xReality object, we can imagine that two users (A and B) are collaborating in the creation of a clock alarm (FIG. 21). User A has the speakers which play the alarm sound and user B has the “snooze” button and the LCD that shows the time. All the objects have a mirrored virtual representation within the virtual world, therefore all of them are xReality objects by itself. However, when combined, they create a mixed-reality clock alarm that reproduces the sound in space A and can be stopped with the button in space B. The final mashup can be seen in the virtual world and users can interact with it from there. For example, user A which only has the speakers could press the virtual “snooze” button with the same effect as if he/she had pressed the physical one. In addition to the communication between pieces (i.e. speakers, LCD, a button), a program needs to be included in the final mashup to add the desired functionality (e.g. stop the sound when pressing the “snooze” button). This program is considered as an additional virtual element (with no physical representation) which allows the combination of available functions for each xReality object (i.e. speakers sound, detection of a button press). Another additional virtual element could be different software processes, threads or apps required for achieving the final functional mashup. Thus, in addition to the combination between mirrored physical/virtual elements, an xReality object includes a combination between soft and hard components that allows it to achieve a desired behaviour.

### Adjustable Mixed-Reality

The scenarios described in the previous section introduce the possibility of having different degrees of mixed-reality between two or more interconnected environments based on communication between xReality objects. The more xReality objects are used in a shared environment, the less simulated the environment is, and vice versa (FIG. 22). Thus, by adding or removing xReality objects in the shared blended-reality environment, it is possible to decrease or increase the amount of virtuality or reality, creating dynamic mixed-reality environments, which can be useful for the creation and testing of functional prototypes in distributed teams, or in collaborative hands-on activities, such as laboratory activities for distance learners.

### Classification of Learning Activities

The creation of the proposed blended-reality distributed architecture poses two different types of challenges: firstly, the creation of a technical infrastructure able to work as a link between remote environments by reflecting information of physical/virtual objects in real-time. Secondly, the ability of such environment to allow remote users performing collaborative activities, to generate a specific outcome, depending on the context where the technology is used (e.g. a learning outcome, a functional prototype, etc.).

The first challenge has been discussed above. Regarding the second challenge, it is necessary first to identify the uses and dimensions of distributed mixed-reality. Lee et al. (2009) identified three key dimensions for ubiquitous virtual reality (U-VR) that can be applied to distributed mixed-reality:
Reality, which refers to the point where the implementation is located in relation with Milgram's virtuality continuum (Milgram and Kishino, 1994).
Context, which refers to the flexibility to change and adapt according to time and space. Context can be presented as a continuum ranging from static to dynamic.
Activity, which refers to the number of people that will execute an activity within the implementation, going from a single user to a large community.

Similarly, Alrashidi et al. (2013) proposed a 4-Dimensional Learning Activity Framework (4DLAT) that classifies learning activities by number of learners and complexity of the task. Thus, as part of the MiReSL model, a classification of learning activities is proposed to identify the affordances of the proposed model, but above all, MiReSL learning activities classification (MiReSL-LA) helps to delimit and design the activities that can be done within the InterReality system (i.e. InterReality Portal and xReality objects).

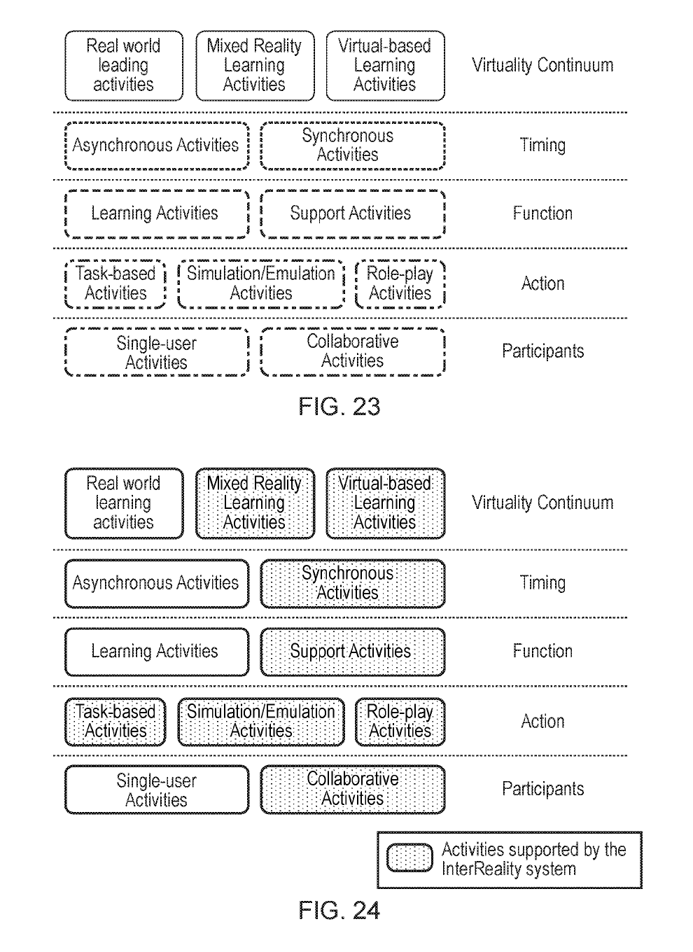

MiReSL-LA (FIG. 23) is formed by
1. Virtuality Continuum-based activities classifies activities in base of their interaction with real and virtual objects.
2. Timing-based activities refer to the time when activities are taking place. For example, synchronous activities involve the execution of activities between two or more participants at the same time (e.g. team-based collaboration); whereas asynchronous activities may be completed individually, (e.g. research, personal assessment, etc.).
3. Function-based activities refer to the nature of the activity itself. For ex-ample, if it is a main Learning Activity such as lectures or a Support Activity such as coursework.
4. Action-based activities refer to the main work being undertaken in the activity. Task-based activities are events that result in a deliverable. Simulation/Emulation activities involve activities with physical-virtual devices. Finally, role-play activities refer to role definitions performed within game structures and supported by co-creative rules
5. By number of participants includes activities designed for an individual (Single-user activities) or for groups of people (Collaborative activities).

This is not a strict classification, as many activities can be classified in two or more categories simultaneously and could fuse with one another in order to create new learning experiences. Based on this classification, FIG. 24 shows the activities available within the proposed InterReality system, which allows the execution of MR learning activities via the use of xReality objects, and virtual-based activities by using just virtual objects on the virtual environment; allowing students without a physical object, to participate in learning sessions. The collaborative nature of the activity makes it synchronous, where students need to gather to coordinate and test different options to achieve a final result. Finally, laboratory activities are, by nature, a complement of the main lecture, a hands-on experience that allows students to correlate theoretical knowledge with real-life activities. Taking this into consideration, tasks within the proposed model can be considered as supporting activities, and due to the hands-on factor, they are task-based and simulated/emulated activities due to the nature of the xReality objects.

In addition to the challenges previously described, the proposed blended-reality distributed architecture presents the challenge of bridging the model of distributed xReality objects with the pedagogical model of constructionist laboratories to produce a solution for distributed mixed-reality laboratories. The use of deconstructionism in a collaborative mixed-reality laboratory architecture can be used to unify a constructionist pedagogy (in which learning is a consequence of the correlation between performing active tasks that construct meaningful tangible objects in the real world and relating them to personal experiences and ideas), with a set of mirrored physical/virtual objects and their supporting soft components (e.g. programs, software processes, threads, apps), which can be construct/deconstruct in different mashups to support science and engineering hands-on activities. Table 1 summarises the affordances of the proposed InterReality System towards the creation of a mixed-reality learning environment formed by multiple interconnected multidimensional spaces, and able to support collaborative hands-on activities within distance learners.

| Affordances | | Description |
|---|---|---|
| 1. | Simulation of real objects | Enable the use of virtual objects. |
| 2. | Emulation using a mixture | Instantiation of diverse scenarios |
| | of real and virtual mirrored | of single and multiple dual-reality |
| | objects (xReality objects) | states. |
| 3. | Creation of physical-virtual | Creation of mashups using services |
| | mashups using a deconstruc- | available in static and nomadic |
| | tionist model | xReality objects. |
| 4. | Collaborative sessions | Support the use and sharing of |
| | between 2 or more users | xReality objects within an environ- |
| | | ment, regardless its physical |
| | | location. |

### Table 1: InterReality System Affordances

The Mixed-Reality Smart Learning model (MiReSL) has been described above as a learning ecosystem based on a conceptual computational architecture that included aspects such as personalisation, content creation, assessment and mixed-reality learning environment. Along with this model, a classification of learning activities (MiReSL-LA) that can be performed in mixed-reality learning environments was proposed to identify the affordances of such model. The MiReSL model was introduced for context. Also provided above is a high-level overview of a mixed-reality distributed computing architecture based on two main supporting concepts that form an InterReality system: The InterReality Portal and xReality objects. The InterReality system was proposed as a solution to bridging virtual and physical worlds, and to merging remote spaces towards the creation of a distributed blended-reality space via the synchronisation of their elements.

Also described above are combinations of synchronised physical and virtual objects based on the principle of dual-reality and the concept of cross-reality first defined by Lifton (2007); Paradiso and Landay (2009), but which, by way of a contribution to the field, were extended from single one-to-one virtual/physical relationships to multiple combinations in different scenarios, exploring different possibilities for managing, sharing and using objects within a blended-reality space; and allowing users to adjust the degree of mixed-reality based on the number of xReality objects used. Both elements of the InterReality system, the InterReality portal and the xReality objects, presented a simple principle which could be applied to different scenarios of collaboration between geographically distributed teams, such as product design in a Research & Development department, or an educational scenario.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A system for generating at least one virtual object corresponding to at least one physical object, wherein the system is arranged to update the virtual object responsive to changes in state of the physical object, and the system is arranged to update the physical object responsive to changes in state of the virtual object.

2. A system according to claim 1, comprising a deconstruction manager mechanism arranged to synchronise the physical object with the virtual object.

3. A system according to claim 2, wherein the deconstruction manager comprises first functionality which identifies the physical object and the virtual object and further functionality which maintains characteristic information relevant for the physical object and the virtual object.

4. A system according to claim 3, wherein the deconstruction manager comprises a continuum manager mechanism arranged to identify the physical object and the virtual object from the first functionality and to identify characteristic information of the physical object and the virtual object from the further functionality, and the deconstruction manager is arranged to link the physical object with the virtual object, thereby enabling the physical object to be synchronised with the virtual object.

5. A system according to claim 2, wherein the deconstruction manager is implemented as software running on a server.

6. A system according to claim 1, wherein the virtual object is displayed at a terminal remote from the physical object and a user can manipulate the virtual object via the terminal, responsive to which, the system is arranged to control the state of the physical object.

7. A system according to claim 1, wherein the system is arranged to generate further virtual objects, corresponding to further physical objects, each further virtual object being associated with one of the further physical objects.

8. A server having software running thereon providing an instance of a deconstruction manager which is arranged to generate and maintain a virtual object associated with a physical object connected via a data connection to the server, said virtual object displayable on a mixed-reality graphical user interface of a user terminal connected to the server.

9. A server according to claim 8, wherein the deconstruction manager is arranged to synchronise the physical object with the virtual object.

10. A server according to claim 9, wherein the instance of the deconstruction manager communicates data to and from the physical object and the user terminal allowing a state of a controllable element of the physical object to be controlled via the mixed-reality graphical user interface of the user terminal.

11. A system for enabling mixed-reality interaction, comprising:
at least one physical object corresponding to at least one virtual object, said physical object responsive to changes in state of the virtual object, and said virtual object responsive to changes in state of the physical object;
a server that manages communication between the physical object and virtual object, and a graphical user interface that enables input to be received from users in remote locations to change the status of the physical object and virtual object and to combine the physical object and virtual object.

12. (canceled)
